(19) United States
(12) Patent Application Publication
(10) Pub. No.: US 2026/0032296 A1
(43) Pub. Date: Jan. 29, 2026

(54) SYSTEMS AND METHODS FOR MANAGING OFFLINE MEDIA CONSUMPTION

(71) Applicant: Warner Bros. Discovery, Inc., New York, NY (US)

(72) Inventor: Andrea FANFANI, London (GB)

(21) Appl. No.: 18/781,430

(22) Filed: Jul. 23, 2024

(51) Int. Cl. H04N 21/234; G11B 27/036; H04N 21/2668; H04N 21/433; H04N 21/45; H04N 21/60; H04N 21/858

(52) U.S. Cl. CPC H04N 21/23424; G11B 27/036; H04N 21/2668; H04N 21/4331; H04N 21/4532; H04N 21/60; H04N 21/8583

(57) ABSTRACT

Systems and methods for integrating offline video consumption with video advertising are disclosed. One computer-implemented method may include: receiving, at a computer system, a request from a mobile application to download a multimedia article for offline consumption on a user device; constructing, using a processor associated with the computer system, a download package containing the multimedia article and a plurality of alternative multimedia articles; transmitting, using the processor, the download package to the mobile application; receiving, at the computer system from the mobile application, offline interaction data associated with the plurality of alternative multimedia articles during the offline consumption of the multimedia article; and reconciling, using the processor, the offline interaction data with online interaction data generated during online consumption of other multimedia articles in the mobile application. Other aspects are described and claimed.

### TECHNICAL FIELD

Various embodiments of the present disclosure relate generally to the field of digital media distribution, and, more particularly, to systems and methods for enabling the offline consumption of media content and integrated advertising.

### BACKGROUND

In the current landscape of over-the-top (OTT) video streaming solutions, many media-streaming platforms allow users to download videos for offline consumption. However, offline content viewing has conventionally been incompatible with video advertising, which typically requires an online connection to serve ads. Consequently, users who download videos for offline viewing miss out on advertisements, thereby impacting ad revenue for OTT providers. Many OTT platforms have addressed this by disabling offline viewing for users on “ad lite” subscription tiers, which results in user frustration. The present disclosure is accordingly directed to systems and methods that may reconcile offline video consumption with advertisement provision.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods are disclosed for managing offline consumption of articles of multimedia content.

In one aspect, a computer-implemented is provided. The computer-implemented method may include operations including: receiving, at a computer system, a request from a mobile application to download a multimedia article for offline consumption on a user device; constructing, using a processor associated with the computer system, a download package containing the multimedia article and a plurality of alternative multimedia articles; transmitting, using the processor, the download package to the mobile application; receiving, at the computer system from the mobile application, offline interaction data associated with the plurality of alternative multimedia articles during the offline consumption of the multimedia article; and reconciling, using the processor, the offline interaction data with online interaction data generated during online consumption of other multimedia articles in the mobile application.

In another aspect, a system is provided. The system may include: a memory including instructions; at least one processor configured to execute the instructions stored in the memory to perform operations comprising: receiving a request from a mobile application to download a multimedia article for offline consumption on a user device; constructing a download package containing the multimedia article and a plurality of alternative multimedia articles; transmitting the download package to the mobile application; receiving, from the mobile application, offline interaction data associated with the plurality of alternative multimedia articles during the offline consumption of the multimedia article; and reconciling the offline interaction data with online interaction data generated during online consumption of other multimedia articles in the mobile application.

In yet another aspect, a non-transitory computer-readable medium storing computer-executable instructions is provided. The computer-executable instructions, when executed by a server in network communication with at least one database, cause the server to perform operations including: receiving, at a computer system, a request from a mobile application to download a multimedia article for offline consumption on a user device; constructing, using a processor associated with the computer system, a download package containing the multimedia article and a plurality of alternative multimedia articles; transmitting, using the processor, the download package to the mobile application; receiving, at the computer system from the mobile application, offline interaction data associated with the plurality of alternative multimedia articles during the offline consumption of the multimedia article; and reconciling, using the processor, the offline interaction data with online interaction data generated during online consumption of other multimedia articles in the mobile application.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts a first exemplary system infrastructure for that integrates offline video consumption with video advertising, according to one or more embodiments of the present disclosure.

FIG. 2 depicts a second exemplary system infrastructure for facilitating offline video play back, according to one or more embodiments of the present disclosure.

FIG. 3 depicts a third exemplary system infrastructure for reporting of offline advertising consumption, according to one or more embodiments of the present disclosure.

FIG. 4 presents a process flow for collectively an exemplary process flow for depict an exemplary user interface of a hosting application embedding a media platform, according to one or more embodiments of the present disclosure.

FIG. 5 depicts an exemplary computing server for enabling offline advertisement consumption and data reconciliation, according to one or more embodiments of the present disclosure.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value.

The term “user”, “subscriber,” and the like generally encompasses consumers who are subscribed to a streaming service (e.g., streaming platform) associated with the system described herein. The term “streaming service” (e.g., streaming platform) may refer to subscription-based video-on-demand (SVoD) services such as television shows, films, documentaries, and the like. The term “user” may be used interchangeably with “user profile,” “profile,” and the like throughout this application. The phrase “registered with” may be used interchangeably with “subscribed to” and the like throughout this application. The phrase “multimedia content” may be used interchangeably with “multimedia content item,” “article of multimedia content,” and the like throughout this application.

OTT solutions refer to platforms or services that deliver video content over the internet, bypassing traditional cable or satellite television providers. Conventionally implemented OTT solutions typically involve standalone applications or websites where users can access a wide range of on-demand and live streaming content on various devices. These platforms often require users to subscribe to a service, either through a monthly subscription or pay-per-view model, to access premium content.

Many OTT media streaming platforms provide a “download to watch” feature that allows users to download videos for offline consumption. This feature is particularly valuable in scenarios where internet connectivity is limited or unavailable, such as during travel. However, challenges arise when attempting to integrate video advertising, also referred to herein as “alternative multimedia articles,” into offline viewing experiences. More particularly, video advertisements are generally served dynamically and require an online connection to fetch and display advertisements in real-time. This incompatibility means that when users download videos for offline viewing, they miss out on advertisements, which results in lost advertising revenue for the OTT provider.

Conventional attempts to address this issue include the creation of “ad lite” subscription tiers, which incorporate advertisements into streaming content while reducing subscription costs. To maintain advertising revenue, many OTT providers have disabled the offline viewing feature for these ad-supported tiers. While this approach preserves ad revenue, it also significantly diminishes the user experience by removing a key functionality that users value. Additionally, the absence of mechanisms to track and report advertisement consumption during offline viewing further complicates the reconciliations of ad metrics and revenue attribution.

To address the above-noted problems, the present disclosure describes systems and methods that allow users to download both video content and associated advertisements for offline consumption. This solution ensures that advertisements are still viewed even when the user is offline, and it enables the application to report advertisement consumption data once the user's device reconnects to the internet. The foregoing solution is achieved through a combination of server-side infrastructure and client-side modules that work together seamlessly, thereby enhancing both the user experience and the revenue for the OTT providers.

The systems and methods described herein represent a variety of technical improvements to computer technology. For instance, the concepts described herein introduce an advanced method for managing large datasets of video content and associated advertisements. By packaging videos and ads together with metadata, the system optimizes the download process and ensures that all necessary information is available offline. This reduces the computational load on client devices and improves the efficiency of data transfer and storage. Additionally, the concepts described herein leverage the capabilities of both server-side and client-side resources to distribute computational tasks effectively. The server-side infrastructure may handle complex tasks such as retrieving content, fetching ads, and packaging them together, while the client-side modules may manage playback and local data recording. This balanced distribution minimizes resource consumption and enhances the overall performance of mobile applications. Furthermore, by enabling the download and offline playback of advertisements, the system extends the functionality of mobile applications beyond traditional online-only environments. This improvement enhances the versatility and usability of mobile devices, allowing users to access a full range of services even without an internet connection.

Although the subject matter disclosed herein is generally described with reference to streamed live broadcasts (e.g., sporting events, concerts, etc.), it is important to note that these designations are not limiting. More particularly, some or all of the embodiments that are subsequently described may be applicable to other types of digital media (e.g., pre-recorded media content such as shows, movies, etc.).

The subject matter of the present disclosure will now be described more fully hereinafter with reference to the accompanying drawings, which form a part hereof, and which show, by way of illustration, specific exemplary embodiments. An embodiment or implementation described herein as “exemplary” is not to be construed as preferred or advantageous, for example, over other embodiments or implementations; rather, it is intended to reflect or indicate that the embodiment(s) is/are “example” embodiment(s). Subject matter may be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof. The following detailed description is, therefore, not intended to be taken in a limiting sense.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

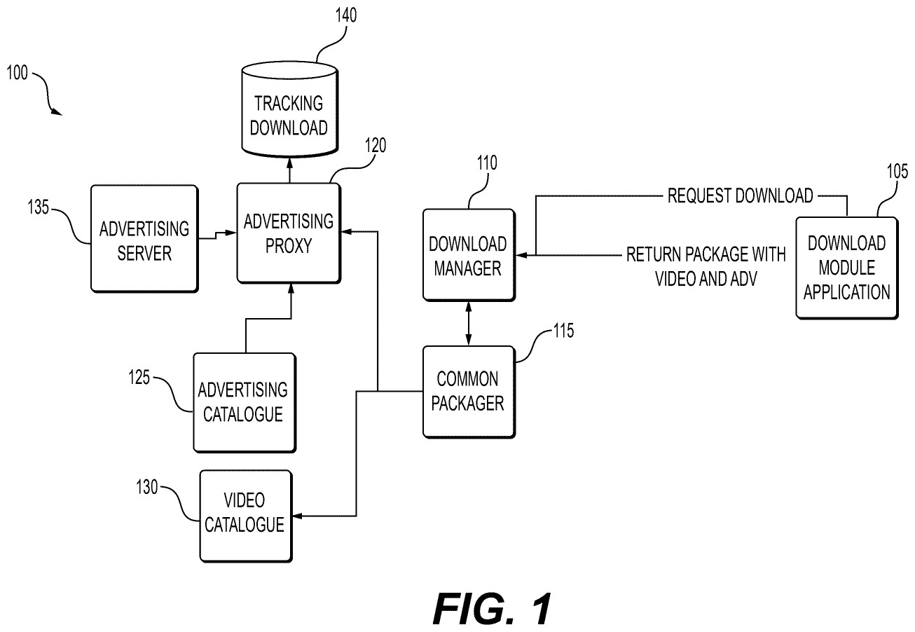

FIG. 1 depicts components of an exemplary system 100 that integrates offline video consumption with video advertising in mobile OTT applications. In an aspect, the components encompassed by this architecture may include each of: a download module application 105, download manager 110, server-side common packager 115, advertising proxy 120, advertising catalogue 125, video catalogue 130, advertising server 135, and tracking download module 140. Each of the foregoing components play an important role in ensuring a seamless experience for downloading and consuming video content along with associated advertisements offline. Although each of the foregoing components is included in FIG. 1, in other aspects, a subset of the foregoing components may be utilized.

In an aspect, the download module 105 may be the component through which users request video downloads. Operating on the client-side, this module provides a user-friendly interface within the mobile application, allowing users to browse and select videos for offline viewing. When a user selects a video for download, the download module 105 sends a request to the download manager 110, which is a central server-side component within system 100 that is designed to orchestrate the entire process of retrieving, packaging, and delivering video content along with associated advertisements to the user's device for offline viewing. The download manager 110 acts as the intermediary between the client-side application and various server-side modules, ensuring that user requests are processed efficiently and accurately.

Upon receiving the download request from the download module 105, the download manager 110 contacts the server-side common packager 115 to initiate the content packaging process. The server-side common packager 115 may be configured to assemble the video content and associated advertisements into a single, cohesive downloadable package. Firstly, the server-side common packager 115 may retrieve the requested video from the video catalogue 130, which serves as a comprehensive repository that stores all available video content offered to users for both online and offline viewing. Concurrently, the server-side common packager 115 may contact the advertising proxy 120 to obtain relevant advertisements. The advertising proxy 120, acting as an intermediary between the server-side common packager 115 and the advertising server 135, handles the fetching and organizing of advertisements. More particularly, advertising proxy 120 may be configured to query the advertising server 135 for appropriate advertisements based on the video content and user context information, retrieve advertisement creatives and metadata, and keep track of the downloaded advertisements for future reconciliation. In an aspect, advertising catalogue 125 may be configured to store metadata about advertisements, facilitating the retrieval process by providing the advertising proxy 120 with necessary details about the advertisements to be included in the package. The advertising proxy 120 may further update the tracking download module 140 with details of the advertisements included in the download, ensuring that ad consumption may be accurately tracked and reported once the user reconnects to the internet.

In an aspect, the advertising server 135 may be configured to store all advertisement content (e.g., including video advertisements, banners, other media formats, etc.) and ensure that advertisements are readily available for distribution upon request from the advertising proxy 120. Alongside the advertisements, advertising server 135 may maintain comprehensive metadata for each advertisement, which may include information such as advertisement duration, target audience, campaign details, and tracking identifiers. In an aspect, when the advertising proxy 120 requests advertisements for packaging with downloadable content, the advertising server 135 may select the appropriate advertisements based on various criteria, such as user context data contained in an accessible user profile, e.g., advertisement preferences (e.g., types of advertisements the user prefers to consume, such as humorous advertisements, informative advertisements, etc.), content viewing preferences (e.g., genres of media the user prefers to consume, favorite actors, actresses, sports teams, etc. that appeal to the user, etc.), user demographic characteristics (e.g., age, geographic location, etc.), viewing history (e.g., content consumed within a predetermined past period of time, such as content consumed in the past week, month, year, etc.), other user preferences (e.g., items or services that the user frequently purchases, types of brands the user purchases, etc.), and the like. The selected advertisements may then be sent to the advertising proxy 120 for inclusion in the download package. In an aspect, the advertising server 135 may periodically refresh the pool of advertisements to ensure that the content remains up-to-date and relevant. If an advertisement has not been watched, it may be replaced with a newer one to keep the advertisement inventory current.

With both the video and advertisement data in hand, the server-side common packager 115 combines them into a single package. This process involves not only integrating the video and advertisements but also including all necessary metadata required for seamless playback and ad tracking. The metadata ensures that the advertisements are displayed correctly during offline viewing and that ad consumption may be accurately logged and reported. Once the packaging process is complete, the server-side common packager 115 returns the assembled content to the download manager 110, which then delivers it to the download module 105 for the user to download and store on their device. Upon receiving the downloadable package from the download manager 110, which includes the video, associated advertisements, and necessary metadata, the download module 105 may store this package locally on the user's device. This storage is optimized for efficient use of device resources while maintaining the integrity of the content. Accordingly, the collective interactions between at least the server-side common packager 115, video catalogue 130, advertising proxy 120, and advertising server 135 ensures that the downloaded package is comprehensive and ready for offline consumption.

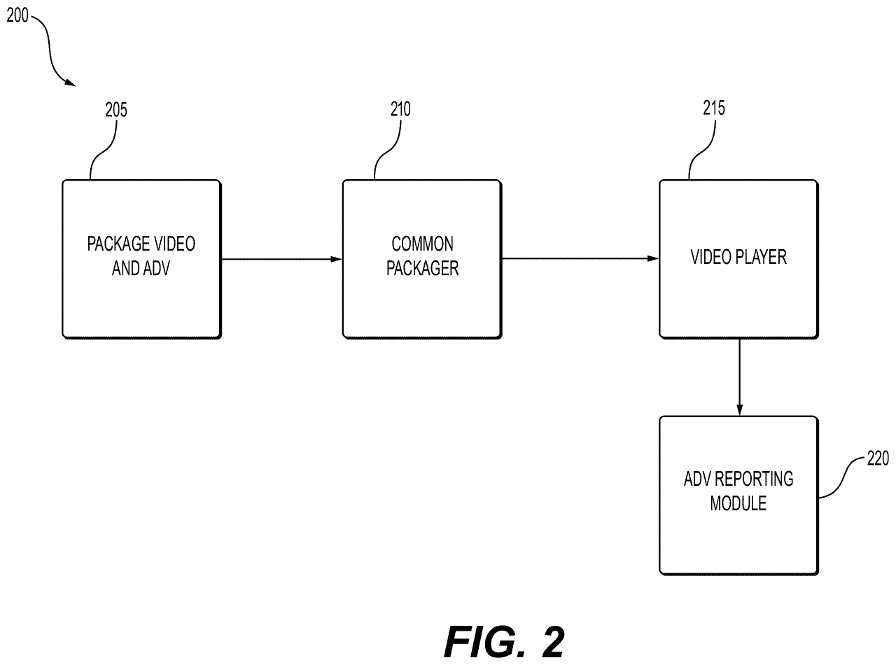

FIG. 2 depicts components of an exemplary system 200 that facilitate offline video playback. The components encompassed by this architecture, include: a package video and advertisement module 205, a client-side common packager 210, video player 215, and advertisement reporting module 220. Some or all of the components illustrated in FIG. 2 may work in conjunction with some or all of the components illustrated in FIG. 1. In one aspect, some or all components in system 200 may function independently from some or all components in system 100. In another aspect, some or all components of systems 100 and 200 may operate together as part of a larger system.

In an aspect, the package video and advertisement module 205 is a representation of a subset of components illustrated in system 100 in FIG. 1 responsible for integrating downloaded video content with associated advertising. Specifically, the package video and advertisement module 205 is responsible for the initial step of retrieving and preparing the content for offline consumption. It gathers the video that the user wants to download, along with the associated advertising creatives. The module ensures that both the main content and the advertisements are correctly packaged together with all necessary metadata required for playback.

In an aspect, the client-side common packager 210 serves as the intermediary that processes the package received from the package video and advertisement module 205. It organizes the video and advertisement content into a unified format that can be easily consumed by the client-side application. This module ensures that the final package is properly structured and ready for offline playback, including any necessary encryption or formatting adjustments.

Video player 215 represents the client-side component responsible for the actual playback of the downloaded content. This player is integrated within the mobile application and serves multiple functions to ensure a smooth and consistent viewing experience. During offline viewing, video player 215 may manage the delivery of both the video content and the pre-downloaded advertisements, as received from the client-side common packager 210. In an aspect, the client-side common packager 210 may act as a feeder to the video player 215, ensuring that the advertisements are shown at the appropriate times during video playback (e.g., “midroll” ads). In an aspect, video player 215 may be designed to handle various formats and resolutions, providing a flexible and robust solution for content consumption.

In an aspect, the advertisement reporting module 220 may be configured to track, store, and report advertisement consumption data. It functions to ensure that advertisement interactions occurring during offline video playback are accurately recorded and subsequently reported when the device reconnects to the internet. This module may operate seamlessly in the background, requiring no additional user interaction, thereby maintaining a smooth and uninterrupted viewing experience. In an aspect, when the user consumes video content offline, the advertisement reporting module 220 may log all relevant data pertaining to the advertisements. This may include the start and end times of each advertisement, any user interactions (e.g., clicks, skips, etc.) with the advertisement, and the overall duration of advertisement views. Ultimately, the module may be designed to capture detailed metrics that are important for advertisers to understand user engagement and advertisement performance. In an aspect, the logged data may be stored locally on the user's device in a secure manner to ensure its integrity until I can be transmitted.

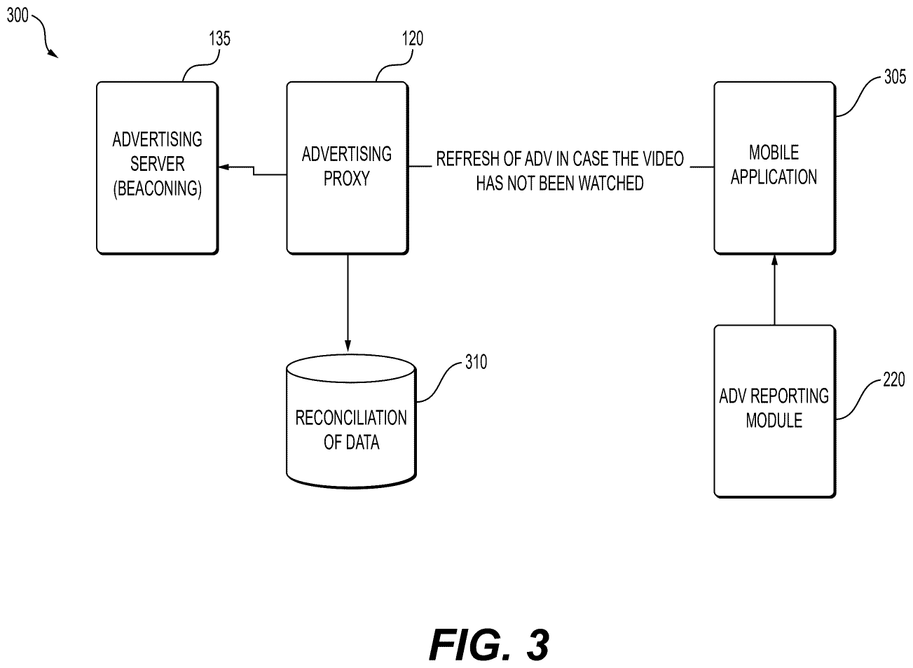

FIG. 3 depicts components of an exemplary system 300 that facilitate the reporting of offline advertising consumption when the mobile application comes back online. The components encompassed by this architecture, include: advertisement reporting module 220, mobile application 305, advertising proxy 120, advertising server 135, and reconciliation of data component 310. Some or all of the components illustrated in FIG. 3 may work in conjunction with some or all of the components illustrated in FIGS. 1 and 2. In one aspect, some or all components in system 300 may function independently from some or all components in systems 100 and 200. In another aspect, some or all components of systems 100, 200, and 300 may operate together as part of a larger system.

When mobile application 305 reconnects to the internet, a series of coordinated actions may occur across several components to ensure that advertisement consumption data collected during offline viewing is accurately reported and updated. In an aspect, this process may begin with mobile application 305, which detects the restoration of the internet connection. Thereafter, the advertisement reporting module 220 within mobile application 305 may initiate the upload of locally stored advertisement consumption data to advertising proxy 120 (e.g., the uploaded data may include detailed records of all advertisements viewed offline and interactions therewith). In an aspect, this transmission may be done asynchronously so that it occurs in the background without interrupting the user's ongoing activities on the device.

Upon receiving the data from the advertisement reporting module 220, the advertising proxy 120 may process and organize the offline advertisement consumption data. In this regard, advertising proxy 120 may ensure that the offline advertisement consumption data is in a format suitable for integration with the advertisement metrics tracked by the advertising server 135. In an aspect, this may involve validating the data for accuracy, checking for completeness, and preparing it for synchronization. Thereafter, advertising proxy 120 may transmit the processed advertisement consumption data to the advertising server 135. This synchronization is important as it ensures that all advertisement interactions, whether they occurred online or offline, are recorded and included in the overall advertisement performance metrics.

In an aspect, when the mobile application reconnects to a network and transmits the offline consumption data to the advertising server 135 via the advertising proxy 120, the advertising server 135 may aggregate this data with the real-time data it has continuously collected. This integration may involve matching the offline consumption data with corresponding advertisements, ensuring that each advertisement interaction, whether it occurred offline or online, is accurately accounted for. In an aspect, the reconciliation process may involve several steps. First, the advertising server 135 may perform a data validation check to verify the integrity and completeness of the received offline data. This may include checking for any discrepancies or missing information that may affect the accuracy of the reconciliation. Once validated, the advertising server 135 may update its records to reflect the offline interactions, a process that may include adjusting the total views, engagement metrics, and any other relevant analytics for each advertisement to incorporate the offline consumption data. After reconciliation, the advertising server 135 may generate an updated report (e.g., by compiling the metrics from the combined offline advertisement interaction data with the online advertisement interaction data). These reports may provide advertisers with detailed insights into the performance of their campaigns, including both offline and online views. This comprehensive data may allow advertisers to make informed decisions about future campaigns and ensures accurate attribution for billing purposes. In an aspect, if the offline consumption data indicates that certain advertisements were not viewed or if there are updates required for the advertisement content, the advertising proxy 120 may trigger a request to the advertising server 135 to refresh the advertisement pool. This may ensure that users receive the most current and relevant advertisements in future sessions.

In an aspect, the reconciliation of data component 310 is a data storage and processing unit that manages the reconciliation of advertisement consumption data. In this regard, reconciled offline consumption data may be received from the advertising server 135, through the advertising proxy 120. Once received, the reconciliation of data component 310 may be configured to temporarily or permanently store the offline advertisement consumption data received from the advertising proxy 120.

Provided below is a non-limiting exemplary situation of consuming and reporting offline content data that involves the systems and components described above. In this example, a user may download a video along with associated advertisements on their mobile device before going on a flight. During the flight, the user watches the video and the advertisements offline. The advertisement reporting module 220 records each advertisement view and interaction locally. Once the flight lands and the user's device reconnects to the internet, the advertisement reporting module 220 sends the recorded data to the advertising proxy 120, which then forwards it to the advertising server 135. The advertising server 135 may reconcile this data with existing online interaction data, providing a complete report to the advertiser that includes both the offline views from the flight and any online views that occurred before and after the flight. This report may be stored in the reconciliation of data component 310 for later analysis.

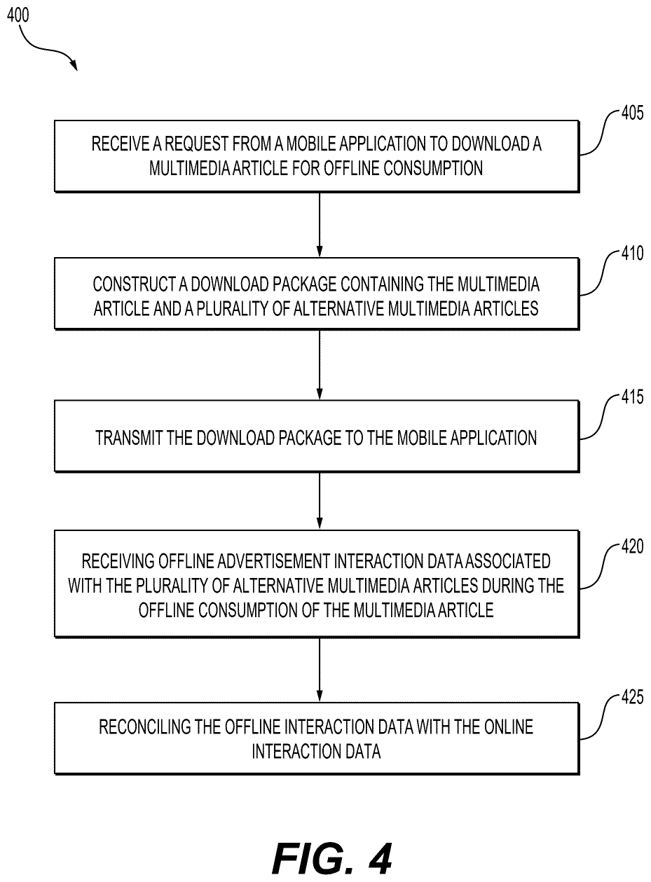

Referring now to FIG. 4, an exemplary process flow 400 for enabling offline advertisement consumption and data reconciliation is provided, according to one or more embodiments of the present disclosure. Exemplary process flow 400 may be implemented by any combination of components included in systems 100, 200, and/or 300. Accordingly, any further reference to a “computer system,” unless specifically designated, may refer to any of computer systems 100, 200, and/or 300.

At step 405, a request from a mobile application may be received at a computer system to download a multimedia article for offline consumption on a user device (e.g., a mobile device such as a smart phone, tablet, laptop computer, hybrid device, etc.). In an aspect, the mobile application may be a multimedia streaming application through which a user may stream multimedia content using their device. The multimedia article may be a video article, an audio article, an audiovisual article, etc., e.g., the multimedia article may be an episode of a television show, a movie, a user-created video clip, a song, etc. In an aspect, the multimedia article may be a single multimedia article (e.g., a single episode of a television show) or may be a plurality of multimedia articles (e.g., all episodes in a season of a television show). In the context of this application, offline consumption of multimedia content may refer to content viewing and interaction when the user's device is not connected to a network (e.g., the Internet, a mobile network, etc.).

At step 410, responsive to receiving the request to download the multimedia article, a computer system may construct a download package that contains: i) the multimedia article; and ii) a plurality of advertisements. The selection of which advertisements to include in the download package may be facilitated in a variety of ways. For instance, in one aspect, a random subset of advertisements may be chosen from an available pool of advertisements to be packaged with the selected multimedia article. In another aspect, a computer system may leverage a dynamic process to select more user-relevant advertisements from the pool of available advertisements. For instance, computer system 100 may receive context data associated with the user, such as advertisement viewing preferences (e.g. types of advertisements the user prefers to watch, products the user prefers to view advertisements for, preferred advertisement length, preferred advertisement position within the multimedia article, etc.), content viewing preferences (e.g., types of multimedia content the user historically prefers to watch, etc.), and user characteristic data (e.g., age, gender, profession, etc.). Computer system may then leverage this information to identify a subset of advertisements from the pool of available advertisements that match some or all of these context parameters in an effort to increase the likelihood of user engagement with the advertisements presented in the download package.

In an aspect, a computer system may include in the download package an advertisement distribution scheme. In an aspect, the advertisement distribution scheme may delineate an order and/or frequency that the plurality of advertisements may be presented to the user throughout their offline consumption of the multimedia article. For example, the advertisement distribution scheme may randomize the order that the advertisements are presented and may present these randomized advertisements at a predefined frequency (e.g., one advertisement every 10 minutes, etc.). In another example, the advertisement distribution scheme may dynamically configure the order at which the advertisements are presented based on consideration of the context data (e.g., those advertisements that match user preferences more closely may be presented before other advertisements that are not as closely associated with the user preferences), the frequency with which they are presented (e.g., more advertisements may be presented earlier in the multimedia article, more advertisements may be presented at critical or popular portions of the multimedia article, e.g., whereby the critical or popular portions are identified from crowdsourced historical user playback data, etc.), and/or a learned way that the user generally consumes the multimedia articles (e.g., if it is known that the user generally starts and stops a media article, the advertisement distribution scheme may present an advertisement upon restarting the media article; if it is known that the user generally consumes an entirety of the multimedia article without stopping, then the advertisement distribution scheme may present advertisements at predetermined points throughout the length of the multimedia article).

At step 415, a may transmit the download package to the mobile application. In an aspect, the user may interact with the download package to download the multimedia article, along with the plurality of advertisements, onto their device. At this stage, the user may view and/or interact with the multimedia article and the plurality of advertisements offline. In an aspect, the user's offline interactions with the advertisements may be tracked, e.g., as described above with reference to the components involved in system 200 in FIG. 2. For instance, data associated with: the length that each advertisement was viewed, whether any advertisement was skipped, whether any advertisement was selected for interaction by the user, etc., may be tracked and saved.

In an aspect, situations may arise where a user may be interested in a product or service that an advertisement is broadcasting and may select the advertisement for further engagement. Because they are consuming the content offline, the user may not be immediately redirected to a conventional destination where additional information and/or purchase opportunities associated with the selected product or service may be available. Rather, in one aspect, an indication of the user's interest in the advertised product or service may initially just be recorded by the mobile application (and may later be transmitted, e.g., to computer system 100 when a network connection is re-established, as further described herein). Additionally or alternatively, in another aspect, the download package may contain additional protocols for some or all of the advertisements that may provide the user with additional product information upon advertisement selection. For example, if a user clicks on an advertisement during their offline consumption of a movie, a popup screen may be presented to the user that provides some limited additional information about the advertised product/service (e.g., product/service price, product/service location, user reviews, company operating hours, company contact information, etc.).

At step 420, a computer system may receive offline advertisement interaction data associated with the plurality of advertisements when the mobile application reconnects to a network. In this regard, all of the stored interactions with the plurality of advertisements that occurred during the offline consumption of the multimedia article may be transmitted back to components of computer system 100 (e.g., as illustrated and described above with systems 100 and 300 in FIGS. 1 and 3).

At step 425, a computer system may reconcile the offline advertisement interaction data with existing online advertisement interaction data. In an aspect, the reconciliation may involve combining the metrics associated with each advertisement in the offline advertisement interaction data with those metrics associated with each corresponding advertisement in track online advertisement interaction data. For instance, advertisement X may be presented to a user at multiple instances, e.g., during online and offline video consumption. A computer system may combine the collective user interaction data associated with advertisement X across both viewing situations. In an aspect, the combined metrics may be dynamically assembled into a report. In an aspect, the report may delineate the offline and online interaction data for each advertisement. In an aspect, the report may be stored and accessed from a storage location associated with the computer system. In another aspect, the report may be transmitted to another destination (e.g., a specific device, a specific system, etc.) at a predetermined interval (e.g., each day, each week, etc.).

In an aspect, a computer system may detect, in the offline advertisement interaction data, that a user had selected to further engage with an advertisement during the offline consumption of the multimedia article. In response, computer system 100 may dynamically transmit information associated with the selected advertisement to the user. For instance, computer system 100 may send product/service information (e.g., a URL link to a website associated with the product/service, additional information about the product/service, etc.) associated with the selected advertisement to an email of the user.

In an aspect, a computer system may receive another request from the mobile application to download another multimedia article to the user device for offline consumption. In response, the computer system may identify one or more previously viewed advertisements by the user. Thereafter, the computer system may construct another download package that contains at least a subset of unviewed advertisements (e.g., new advertisements that the computer system determined the user had not seen before). In this way, computer system 100 may refresh and update the types of advertisements that are presented to the user during offline consumption in an effort to increase engagement.

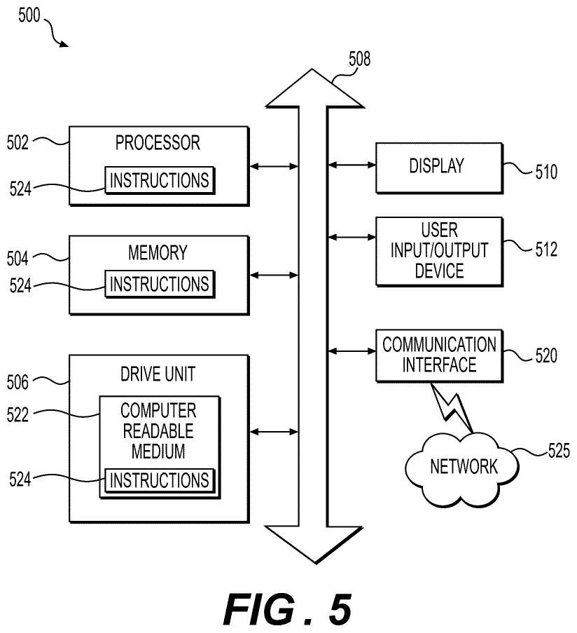

In general, any process discussed in this disclosure that is understood to be computer-implementable, such as the processes illustrated in FIG. 5, may be performed by one or more processors of a computer system, such as computer systems 100, 200, and 300 described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer server. A processor may be a central processing unit (CPU), a graphics processing unit (GPU), or any suitable types of processing unit.

A computer system, such computer systems 100, 200, and 300, may include one or more computing devices. If the one or more processors of the computer systems are implemented as a plurality of processors, the plurality of processors may be included in a single computing device or distributed among a plurality of computing devices. If any of computer systems 100, 200, or 300 comprises a plurality of computing devices, the memory of the computer systems 100, 200, or 300 may include the respective memory of each computing device of the plurality of computing devices.

FIG. 5 is a simplified functional block diagram of a computer system 500 that may be configured as a computing device for executing the process illustrated in FIG. 4, according to exemplary embodiments of the present disclosure. FIG. 5 is a simplified functional block diagram of a computer that may be configured as the computer systems 100, 200, and/or 300 according to exemplary embodiments of the present disclosure. In various embodiments, any of the systems herein may be an assembly of hardware including, for example, a data communication interface 520 for packet data communication. The platform also may include a central processing unit (“CPU”) or processor 502, in the form of one or more processors, for executing program instructions. The platform may include an internal communication bus 508, and a storage unit 506 (such as ROM, HDD, SDD, etc.) that may store data on a computer readable medium 522, although the system 500 may receive programming and data via network communications via electronic network 525 (e.g., voice, video, audio, images, or any other data over the electronic network 525). The system 500 may also have a memory 504 (such as RAM) storing instructions 524 for executing techniques presented herein, although the instructions 524 may be stored temporarily or permanently within other modules of system 500 (e.g., processor 502 and/or computer readable medium 522). The system 500 also may include input and output devices 512 and/or a display 510 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

In general, any process discussed in this disclosure that is understood to be performable by a computer may be performed by one or more processors. Such processes include, but are not limited to: the process shown in FIG. 5, and the associated language of the specification. The one or more processors may be configured to perform such processes by having access to instructions (computer-readable code) that, when executed by the one or more processors, cause the one or more processors to perform the processes. The one or more processors may be part of a computer system (e.g., one of the computer systems discussed above) that further includes a memory storing the instructions. The instructions also may be stored on a non-transitory computer-readable medium. The non-transitory computer-readable medium may be separate from any processor. Examples of non-transitory computer-readable media include solid-state memories, optical media, and magnetic media.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

1. A computer-implemented method, the computer-implemented method comprising operations including:
receiving, at a computer system, a request from a mobile application to download a multimedia article for offline consumption on a user device;
constructing, using a processor associated with the computer system, a download package containing the multimedia article and a plurality of alternative multimedia articles, wherein the download package comprises a distribution scheme that delineates an order and a frequency for presenting the plurality of alternative multimedia articles during the offline consumption, the order and the frequency being dynamically determined based on user content viewing preference data;
transmitting, using the processor, the download package to the mobile application;
receiving, at the computer system from the mobile application, offline interaction data associated with the plurality of alternative multimedia articles during the offline consumption of the multimedia article; and
reconciling, using the processor, the offline interaction data with online interaction data generated during online consumption of other multimedia articles in the mobile application.

2. The computer-implemented method of claim 1, wherein the multimedia article is one of: an audio article, a video article, or an audiovisual article.

3. The computer-implemented method of claim 1, wherein the mobile application is a multimedia streaming platform.

4. The computer-implemented method of claim 1, wherein the constructing comprises:
identifying context data associated with a user of the mobile application;
determining which types of alternative multimedia articles from a pool of available alternative multimedia articles match the context data; and
including, in the plurality of alternative multimedia articles, at least one of the alternative multimedia articles from the pool of available alternative multimedia articles that match the context data.

5. The computer-implemented method of claim 4, wherein the context data comprises: alternative multimedia article viewing preferences, content viewing preferences, and user characteristic data.

6. The computer-implemented method of claim 1, wherein the offline interaction data includes metrics corresponding to one or more of: a viewing duration for at least one of the plurality of alternative multimedia articles, a user skip action for any of the plurality of alternative multimedia articles, a user selection action for any of the plurality of alternative multimedia articles, or a viewing start and a viewing end time for the at least one of the plurality of alternative multimedia articles.

7. The computer-implemented method of claim 1, wherein the reconciling comprises combining metrics from the offline interaction data with the online interaction data.

8. The computer-implemented method of claim 7, further comprising:
compiling the metrics from the combined offline interaction data with the online interaction data into a report; and
transmitting, at a predetermined time, the report to a designated network.

9. The computer-implemented method of claim 1, further comprising:
identifying, from the offline interaction data, a user-selected alternative multimedia article from the plurality of alternative multimedia articles during the offline consumption of the multimedia article; and
transmitting, based on the identified user-selected alternative multimedia article and through the mobile application, information to the user device.

10. The computer-implemented method of claim 1, further comprising:
receiving, at the computer system, another request from the mobile application to download another multimedia article to the user device for offline consumption;
identifying one or more previously viewed alternative multimedia article from the plurality of alternative multimedia article;
constructing another download package containing the another multimedia article and a second plurality of alternative multimedia articles, wherein the second plurality of alternative multimedia articles contain unviewed alternative multimedia articles in place of the one or more previously viewed alternative multimedia articles; and
transmitting the another download package to the mobile application.

11. A system comprising:
a memory including instructions; and
at least one processor configured to execute the instructions stored in the memory to perform operations comprising:
receiving a request from a mobile application to download a multimedia article for offline consumption on a user device;
constructing a download package containing the multimedia article and a plurality of alternative multimedia articles, wherein the download package comprises a distribution scheme comprising metadata that delineates an order and frequency for presenting the plurality of alternative multimedia articles during offline consumption, the order and frequency being dynamically determined based on user content viewing preference data;
transmitting the download package to the mobile application;
receiving, from the mobile application, offline interaction data associated with the plurality of alternative multimedia articles during the offline consumption of the multimedia article; and
reconciling the offline interaction data with online interaction data generated during online consumption of other multimedia articles in the mobile application.

12. The system of claim 11, wherein the multimedia article is one of: an audio article, a video article, or an audiovisual article.

13. The system of claim 11, wherein the operations for constructing further comprise:
identifying context data associated with a user of the mobile application;
determining which types of alternative multimedia articles from a pool of available alternative multimedia articles match the context data; and
including, in the plurality of alternative multimedia articles at least one of the alternative multimedia articles from the pool of available alternative multimedia articles that match the context data.

14. The system of claim 13, wherein the context data comprises: alternative multimedia article viewing preferences, content viewing preferences, and user characteristic data.

15. The system of claim 11, wherein the offline interaction data includes metrics corresponding to one or more of: a viewing duration for at least one of the plurality of alternative multimedia articles, a user skip action for any of the plurality of alternative multimedia articles, a user selection action for any of the plurality of alternative multimedia articles, or a viewing start and a viewing end time for at least one of the plurality of alternative multimedia articles.

16. The system of claim 11, wherein the operations for reconciling further comprise:
combining metrics from the offline interaction data with the online interaction data.

17. The system of claim 16, wherein the operations further comprise:
compiling the metrics from the combined offline interaction data with the online interaction data into a report; and
transmitting, at a predetermined time, the report to a designated network.

18. The system of claim 11, wherein the operations further comprise:
identifying, from the offline interaction data, a user-selected alternative multimedia article from the plurality of alternative multimedia articles during the offline consumption of the multimedia article; and
transmitting, based on the identified user-selected alternative multimedia article and through the mobile application, information to the user device.

19. The system of claim 11, wherein the operations further comprise:
receiving another request from the mobile application to download another multimedia article to the user device for offline consumption;
identifying one or more previously viewed alternative multimedia articles from the plurality of alternative multimedia articles
constructing another download package containing the another multimedia article and a second plurality of alternative multimedia articles wherein the second plurality of alternative multimedia articles contain unviewed alternative multimedia articles in place of the one or more previously viewed alternative multimedia articles; and
transmitting the another download package to the mobile application.

20. A non-transitory computer-readable medium storing computer-executable instructions which, when executed by a server in network communication with at least one database, cause the server to perform operations comprising:
receiving, at a computer system, a request from a mobile application to download a multimedia article for offline consumption on a user device;
constructing, using a processor associated with the computer system, a download package containing the multimedia article and a plurality of alternative multimedia articles, wherein the download package comprises a distribution scheme comprising metadata that delineates an order and frequency for presenting the plurality of alternative multimedia articles during offline consumption, the order and frequency being dynamically determined based on user content viewing preference data;
transmitting, using the processor, the download package to the mobile application;
receiving, at the computer system from the mobile application, offline interaction data associated with the plurality of alternative multimedia articles during the offline consumption of the multimedia article; and
reconciling, using the processor, the offline interaction data with online interaction data generated during online consumption of other multimedia articles in the mobile application.
